(19) United States
(12) Patent Application Publication
(10) Pub. No.: US 2016/0283887 A1
(43) Pub. Date: Sep. 29, 2016

(54) SYSTEM AND METHOD FOR AGRICULTURAL ACTIVITY MONITORING AND TRAINING

(71) Applicant: Tata Consultancy Services Limited, Mumbai (IN)

(72) Inventors: Bhushan Gurmukhdas JAGYASI, Thane (IN); Somya SHARMA, Thane (IN); Jabal Udayankumar RAVAL, Thane (IN)

(73) Assignee: Tata Consultancy Services Limited, Mumbai (IN)

(21) Appl. No.: 15/065,624

(22) Filed: Mar. 9, 2016

(30) Foreign Application Priority Data
Mar. 26, 2015 (IN) 1015/MUM/2015

(51) Int. Cl. G06Q 10/06; G06Q 50/02

(52) U.S. Cl. CPC G06Q 10/06398; G06Q 50/02

(57) ABSTRACT

The method and system for a computer implemented agricultural activity monitoring and training is described herein. The system comprises a plurality of sensors to sense the agriculture activities and environment parameters to generate sensor data. A transceiver presents in the system transfer the sensor data to the server. The server comprises a activity detection module to detect the agriculture activities performed by an individual. A monitoring feedback generator to generate a monitoring feedback based on detected activity. A remote training module determines a performance score of the activity performed by the individual and sends training feedback to the individual based on the performance score.

### PRIORITY CLAIM

This U.S. patent application claims priority under 35 U.S.C. §119 to: India Application No. 1015/MUM/2015, filed on Mar. 26, 2015. The entire contents of the aforementioned application are incorporated herein by reference.

### TECHNICAL FIELD

This disclosure relates to the field of remote training and remote monitoring with respect to agriculture.

### BACKGROUND

In most parts of the world, individuals are still using traditional methods for agriculture. Nevertheless, these means are unable to keep pace up with the needs of growing world population. To meet the end of the growing world needs, individuals and growers have to learn new techniques of farming which in turn help the individuals by improvement in yield, reduction in farming cost, reduction in destruction to the environment and increase in the quality of produce.

However, there are a quite number of difficulties which individuals have to undergo through while learning the new techniques. Activities being performed on a farm need to be detected and updated for improving the decision making process in agriculture.

Farmer training is the kind of education which is different from education in schools as it takes place outside the formal learning institutions. Most of the farmers having farm in the rural areas find the agriculture training burdensome because they have to leave their farms unattended for attending the training sessions at faraway places.

Another problem subsist in this field is that there are very less number of agriculture experts, so it's practically impossible for these experts to train large sets of individuals present in the different parts of the world, about the contemporary agricultural techniques and best farming practices by being physically present. Additionally, in the conventional training sessions, it is difficult to monitor the activities of the individuals to determine whether they have learned and incorporated the farming techniques correctly. Further, in a scenario where a supervisor has to monitor the work done by individuals, it is challenging for the supervisor to monitor and asses' productivity of the individuals based on their activities.

Therefore, there exists a need in the art which combines the traditional domain knowledge with the modern technology to provide diverse agriculture knowledge which will be easy to understood and readily used by the user.

### SUMMARY

This summary is provided to introduce concepts related to a computer implemented agricultural activity monitoring and training system and a method thereof, which is further described below in the detailed description. This summary is not intended to identify essential features of the claimed subject matter, nor is it intended for use in determining or limiting the scope of the claimed subject matter.

The system and method for agriculture activity monitoring and training includes detecting an agricultural activity performed by the individual. These activities are sensed by processing the data obtained by the on-body sensors and/or on-farm sensors (sensors positioned at various locations in the farm). The sensor senses data with respect to pre-determined parameters. The sensed data transmitted to the remotely located server. A server receives the sensed data and process the sensed data in real time and provides suggestions to the farmers. The processing of sensed data can either happen on the sensor nodes or on the servers.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a computer implemented system for agricultural activity monitoring and training, in accordance with the present claimed subject matter.

FIG. 2 illustrates a flow diagram showing the steps involved in agricultural activity monitoring and training, in accordance with the present claimed subject matter.

FIG. 3 illustrates an exemplary embodiment of the system showing the agriculture activity remote monitoring, in accordance with the present claimed subject matter.

FIG. 4 illustrates an exemplary embodiment of the system showing the agriculture remote training, in accordance with the present claimed subject matter.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

A computer implemented system and method for monitoring and training an individual involved in agricultural activity will now be described with reference to the embodiment shown in the accompanying drawing. The embodiment does not limit the scope and ambit of the disclosure. The description relates purely to the examples and preferred embodiments of the disclosed system and its suggested applications

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium ay store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The present claimed subject matter envisages a computer implemented agricultural activity monitoring and training system. The system utilizes information related to a particular crop and the type of activities to be performed in the agricultural farms. The system is capable of analyzing the data received from a plurality of sensor for determining the activities performed by the individuals in their respective agricultural farms with high accuracy.

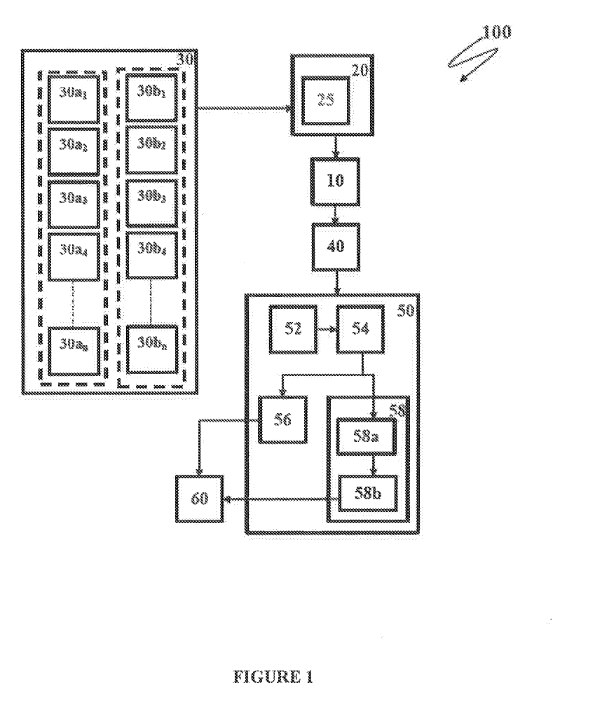

Referring to FIG. 1, illustrates a system 100 for agricultural activity monitoring and training. The system 100 comprises: a processor 10, a memory 20, a plurality of sensors 30, a transceiver 40, a server 50 and a communicator 60.

The processor 10 is coupled to the memory 20. The processor 10 may be implemented as one or more microprocessors, microcomputers, microcontrollers, digital signal processors, central processing units, state machines, logic circuitries, and/or any devices that manipulate signals based on operational instructions. Among other capabilities, the processor 10 configured to fetch and execute predetermined set of rules stored in the memory 20.

In an embodiment, the processor 10 is also configured to receive a plurality sensor data stored in memory 20, which is generated by the plurality of sensors 30. The processor 10 is further configured to process the plurality sensor data to obtain a plurality of processed sensor data.

The memory 20 comprises a system repository 25 is configured to store predetermined set of rules. The system repository 25 can include any computer-readable medium known in the art including, for example, volatile memory (e.g., RAM), and/or non-volatile memory (e.g., EPROM, flash memory, etc.).

In an embodiment, the memory 20 may be a storage memory of any PDA, computer or server. The memory 20 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In another embodiment the system repository 25 is configured to store sensor data generated by the plurality of sensors 30.

The plurality of sensors 30 cooperates with the system processor 10 to receive system processing commands. The plurality of sensors 30 is configured to sense the agriculture activities performed by the individuals and environmental parameters to generate plurality of sensor data.

The plurality of sensors 30 comprises on-body sensors 30a1 to 30an and on-field sensors 30b1 to 30bn. The on-body sensors 30a1 to 30an are the sensors that can be carried by the individuals in the farms configured to sense the activities performed by the individuals. The on-body sensors 30a1 to 30an may include but is not limited to global positioning system (GPS), accelerometer, camera, microphone, magnetometer, and gyroscope and proximity sensor. The GPS module determines the location of the individual performing an agricultural activity. The accelerometer determines the acceleration which further deduces the attributes related to the gesture of the individual working in the field. The proximity sensor detects the presence of nearby objects with respect to the individual. In an embodiment inbuilt sensors of handheld computing devices (smart phones, tabs, IPad etc.) can be used to detect activity performed by individuals in the field.

In an embodiment the data generated by the on-body sensors 30a1 to 30an may be further used to determine the different attributes like speed and based on these features, gestures/activity performed by the individual are determined.

The on-field sensors 30b1 to 30bn are the sensors that are typically, installed at the site or in the farms for sensing the environmental data with respect to agricultural parameters. The agricultural parameters may include but is not limited to water availability deployment, weather forecast, soil moisture, temperature, humidity, leaf wetness, sunlight availability, gaseous content in the soil, fertilizer content in the soil, growth of crop, pesticide content on the crop, and agricultural activities performed by the individuals in their farms. The on-farm sensors 30b1 to 30bn may include but is not limited to temperature sensor, humidity sensor, soil moisture sensor, leaf wetness sensor, gas sensors, actinometer, dew warning sensor and ceilometer.

In an embodiment, the plurality of sensor data generated by the plurality of sensors 30 is stored in the system repository 25.

In another embodiment, the plurality of sensor data generated by the plurality of sensors 30 is processed by microprocessors present on the plurality of sensors.

The transceiver 40 is configured to cooperate with the processor 10 to receive the plurality of processed sensor data. The transceiver 40 is configured to transmit the sensor data.

The server 50 cooperates with the transceiver 40 to receive the plurality of processed sensor data. The server 50 comprises: a server repository 52, a activity detection module 54, a monitoring feedback generator 56 and a training module 58. The server epository 52 is configured to store predefined activity data, and a crop protocol data.

In an embodiment, the server repository 52 may be present in the memory 20.

The predefined activity data comprises a set of sensed data with respect to different agriculture activities. The agriculture activities may include but are not limited to land preparation, planting, transplanting, manual weeding, spraying of chemicals, irrigating, ploughing, supervision, surveillance, tilling, growing and harvesting. It holds the data about the ideal/best way of performing any agriculture activity, which results in improvement in yield, reduction in farming cost, reduction in destruction of the environment, increase in the quality of yield or provide any improvement in any other parameters related to agriculture. In an embodiment the predefined activity data is generated based on the agriculture activity performed by the agriculture expert. On-body sensors are placed on the body of the agriculture expert while the expert is performing an agriculture activity in a preferred way, on-body sensors captures the various aspects of that activity (speed, body gesture, acceleration, movement and the etc.) and generate sensor data corresponding to that activity and a predetermined ideal activity model is generated based on said generated sensor data. Simultaneously, a video documentary depicting the agriculture expert performing the agriculture activity in a preferred way is recorded. Further, this video documentary can be used by an individual for learning the agriculture activities in a best way. After undergoing the video based learning phase, when the individual (trainee farmer) performs the activity by wearing the sensors or deploying the sensors on the farm, the activity performance score is generated for imparting training guidelines to the individual (trainee farmer).

The crop protocol data determines the likelihood of particular activity based on the spatial-temporal parameters data, agriculture domain data and crop life cycle data. The crop protocol data comprehends the activity which is scheduled during a particular time frame is more likely to happen. In an exemplary embodiment, wherein the sowing date of the wheat crop is known, the likelihood of harvesting the crop in fourth week is very less, whereas likelihood of fertilizing the crop is comparatively high.

The activity detection module 54 having a comparator (not shown in figure) cooperates with the server repository 52 to receive the predefined activity data and the crop protocol data. The activity detection module 54 is configured to compare the plurality of processed sensor data with the predefined activity data and the crop protocol data to detect an agriculture activity. In an exemplary embodiment if the activity detection module 54 based on the comparison of the plurality sensor data with the predefined activity data may detects more than one agriculture activities because of closely correlated sensors data, the crop protocol data helps to narrow down on a single agriculture activity.

In an exemplary embodiment, wherein the individual is fertilizing his wheat fields, the activity detection module 54 based on comparisons of the plurality of processed sensor data with the predefined activity data has detected two agriculture activities: fertilizing or weed control because of closely correlated sensors data. In this example, the crop protocol data helps to determine the agriculture activity accurately. In this example, date of sowing of the wheat crop is known, the probability of weed control in second week is very less, whereas probability of fertilizing the crop is comparatively high. The monitoring feedback generator 56 cooperates with the activity detection module 54 to receive the detected activity and configured to generate a monitoring feedback based on the detected activity. In an embodiment, the feedback can be a necessary suggestion or instruction to the individual on the farm. In another embodiment analyzed data is provided to the admin/supervisor/expert through the monitoring feedback generator 56. The automatically generated feedback is based on the sensor parameters collected while an individual is taking the training. For example, without limited to these examples, it may provide feedback on the strength applied while plowing activity, concentration of chemical spraying, speed of a particular activity, etc. The remotely located admin/supervisor/expert monitor the agriculture activity being performed on his farm and responds with the monitoring feedback.

Further, the training module 58 comprising a performance score determiner 58a and a training feedback generator 58b. The performance score determiner 58a cooperates with the activity detection module 54 to receive the detected agriculture activity. The performance score determiner 58a is configured to determine a performance score of the detected agriculture activity based on the comparison of the plurality sensor data with the predefined activity data wherein the predefined activity data holds the data about the ideal/best way of performing any agriculture activity. The performance score indicates how well an individual has performed the activity with respect to the ideal way of performing an activity.

in an embodiment, the training module 58 works independently of the activity detection module 54. The performance score determiner 58a is configured to receive plurality of sensor data from the transceiver 40 and the predefined activity data from the server repository. The performance score determiner 58a is further configured to is configured to determine a performance score of the detected agriculture activity based on the comparison of the plurality sensor data with the predefined activity data wherein the predefined activity data holds the data about the ideal/best way of performing any agriculture activity.

The training feedback generator 58b cooperates with the performance score determiner 58a to receive the performance score. The training feedback generator 58b is configured to generate a training feedback based on the performance score. In an embodiment, the performance score is provided to the admin and/or supervisor and/or expert for providing feedback. The remotely located admin and/or supervisor and/or expert monitor the agriculture activity being performed in the farm and provide the training feedback to the individual working in the farm. In another embodiment, the training feedback may be an instruction or suggestion or appreciation to the individual.

The communicator 60 cooperates with the monitoring feedback generator 56 to receive the monitoring feedback and the training feedback generator 58b to receive the training feedback. The communicator 60 is configured to communicate the monitoring feedback and training feedback to the individual engaged in agriculture activity. In an embodiment, the communicator may be a desktop or a laptop or a mobile phone or a tablet capable of communicating with the user. In another embodiment, the training feedback or monitoring feedback may be communicated through text, phone call, interactive voice call or any combination thereof.

In an exemplary embodiment, the individual who wants to learn about farming practices may go through training materials such as a video showing the best practices, the individual may use the mobile phone application and the other sensor to record the data of the activity he is performing. The activity data may be communicated to the server 60 and will be compared with the predefined activity data and crop protocol data.

Alternatively, the processing may also be done on the hand held device such as a mobile device or a tablet without communicating the data to the server 50. The parameters generated from users activity may be compared to the ideal way of doing activity depicted in the video (predetermined ideal activity model). Based on the comparison, a data performance score may be generated. The data performance score is an index/measure of how well the performed activity was with respect to ideal activity. The data performance score is than communicated to the user using the communicator 60.

The systems and methods are not limited to the specific embodiments described herein. In addition, components of each system and each method can be practiced independently and separately from other components and methods described herein. Each component and method can be used in combination with other components and other methods.

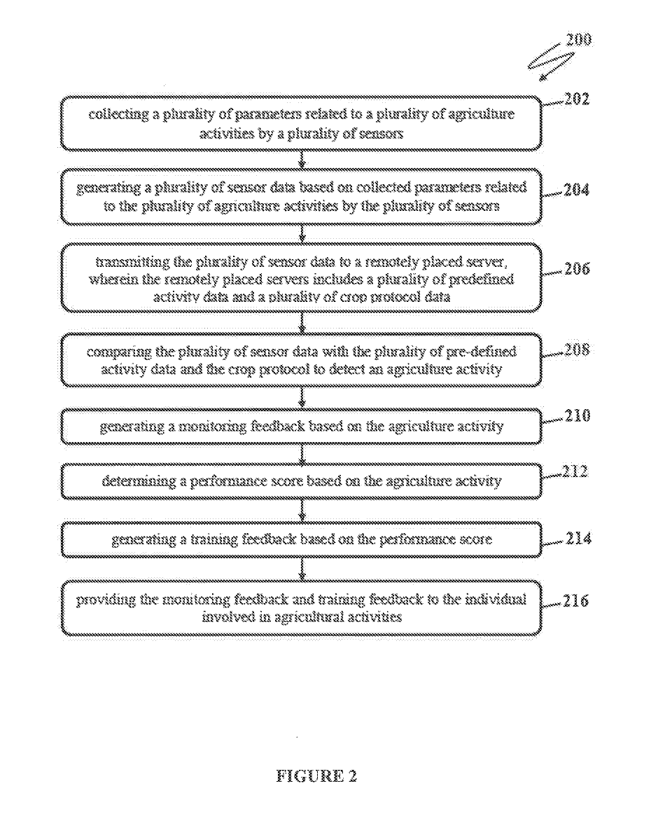

Referring to FIG. 2, illustrates a method 200 for monitoring and training an individual involved in agriculture activities.

At block 202, plurality of sensors 30 (shown in FIG. 1) collects a plurality of parameters related to plurality of agriculture activities and agriculture parameters. The plurality of sensors 30 comprises on-body sensors 30a1 to 30an and on-field sensors 30b1 to 30bn. The on-body sensors 30a1 to 30an are the sensors that may be carried by the individuals in the farms configured to sense the activities performed by the individuals. The on-field sensors 30b1 to 30bn are the sensors that are typically, installed at the site or in the farms for sensing the environmental data with respect to agricultural parameters. The agricultural parameters may include but is not limited to water availability deployment, weather forecast, soil moisture, temperature, humidity, leaf wetness, sunlight availability, gaseous content in the soil, fertilizer content in the soil, growth of crop, pesticide content on the crop, and agricultural activities performed by the individuals in their farms.

At block 204, the plurality of sensors generates plurality of sensor data based on the collected parameters related to agriculture activities and agriculture parameters.

At block 206, plurality of sensor data generated by plurality of sensors 30 (shown in FIG. 1) is received by the transceiver 40 (shown in FIG. 1) and further transmitted to the remotely placed server 50.

In an embodiment, the plurality of sensor data is first stored in the system repository 25. Further, the plurality of sensor data is processed by the processor 10 to obtain a plurality of processed sensor data.

At block 208, plurality of sensor data is compared with the predefined activity data and crop protocol data to detect an agriculture activity. The predefined activity data comprises a set of sensed data with respect to different agriculture activities. It holds the data about the ideal/best way of performing any agriculture activity. The crop protocol data determines the likelihood of particular activity based on the spatial-temporal parameters data, agriculture domain data and crop life cycle data. The crop protocol data comprehends the activity which is scheduled during a particular time frame is more likely to happen.

At block 210, monitoring feedback is generated by the monitoring feedback generator 56 based on the agriculture activity which is detected by the activity detection module 54. The monitoring feedback may be a necessary suggestion or instruction to the individual on the farm. In another embodiment analyzed data is provided to the admin/supervisor/expert through the monitoring feedback generator 56. The remotely located admin/supervisor/expert monitor the agriculture activity being performed on his farm and responds with the monitoring feedback.

At block 212, performance score is determined for the detected agriculture activity based on the comparison of the plurality of sensor data with the predefined activity data wherein the predefined activity data holds the data about the ideal/best way of performing any agriculture activity. The performance score indicates how well an individual has performed the activity with respect to the ideal way of performing an activity.

At block 214, training feedback is generated based on the performance score In an embodiment performance score is provided to the admin/supervisor/expert for providing monitoring feedback. The remotely located admin/supervisor/expert monitor the agriculture activity being performed in the farm and provide the training feedback to the individual working in the farm. In another embodiment training feedback could be an instruction or suggestion or appreciation to the individual.

At block 216, the monitoring feedback and the training feedback is provided to the individual involved in agriculture activity. The communicator 60 cooperates with the monitoring feedback generator 56 and training feedback generator 58b. In an embodiment, the monitoring feedback and the training feedback is provided to the individual through the desktop or laptop or mobile phone or tab.

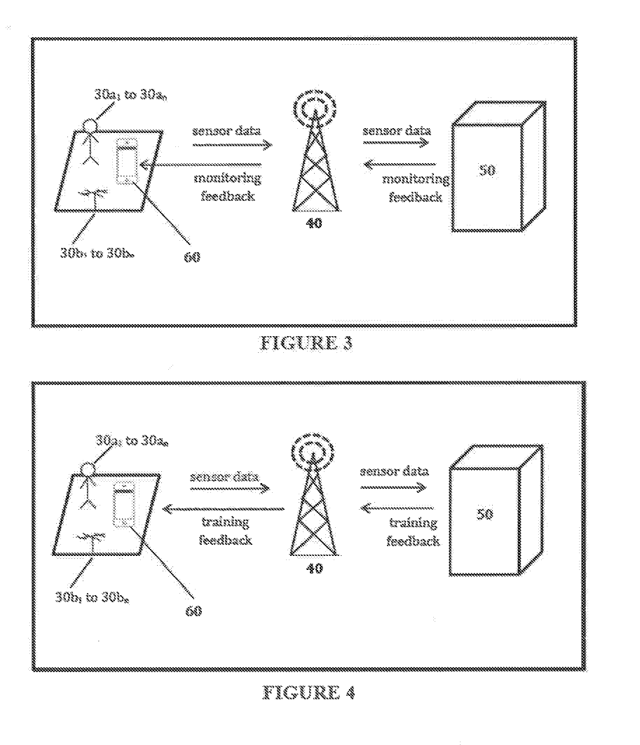

Referring to FIG. 3, illustrates an exemplary embodiment of the system showing remote monitoring of the agricultural activity performed by an individual. In this embodiment, the individual is performing an agriculture activity (land preparation, planting, transplanting, growing and harvesting) in the field, wherein the on-body sensors 30a and on-field sensors are collecting the parameters related to agriculture activity and generating a sensor data. This sensor data with the help of transceiver 40 is sent to the server 50 for further processing. On server 50 sensor data is compared with the stored predefined activity data and the crop protocol data to detect an agriculture activity. Further based on the detected activity a monitoring feedback is sent to the individual through the communicator 60, wherein the monitoring feedback may be generated by the admin/supervisor/expert.

Referring to FIG. 4, illustrates an exemplary embodiment of the system showing the remote training of the agricultural activity. In this embodiment, the agriculture expert will perform the agriculture activity in the ideal way in the farm, wherein the agriculture expert and farm is equipped with on-body sensors and on-field sensors to sense the parameters related to agriculture activity and environment. Simultaneously, a video has been recorded which may be used for the training purposes. The sensed agriculture activity of the expert is stored at server as a predefined activity data. The individual, who wants to learn the new technique, will watch the video and try to perform the same activity in his own field wherein the individual and farm is equipped with on-body sensors 30a1 to 30an and on-field sensors 30b1 to 30bn to sense the parameters related to agriculture activity. The sensed activity of the individual is sent to the server with the help of transceiver 40. The sensed activity of the individual is compared with the predefined activity data to determine the performance score of the individual's activity. And based on the performance score the expert will provide the suggestions to perform the activity correctly.

A computer implemented agricultural activity monitoring and training system and a method thereof of the present claimed subject matter include the realization of:
a computer implemented system and method for agricultural activity monitoring;
a system that remotely guides individuals about the best farming practices;
a system that provide a system that accurately monitors the farm worker activities
a system that that scores the performance of farm worker; and
a system that combines agriculture domain knowledge along with the sensor data.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

It is intended that the disclosure and examples be considered as exemplary only, with a true scope and spirit of disclosed embodiments being indicated by the following claims.

What is claimed is:

1. A computer implemented method for monitoring agriculture activities and training an individual involved in the agricultural activities, the method comprising;
collecting a plurality of parameters related to a plurality of agriculture activities by a plurality of sensors;
generating a plurality of sensor data based on the collected parameters related to the plurality of agriculture activities by the plurality of sensors;
transmitting the plurality of sensor data to a remotely placed server, wherein the remotely placed server comprises a plurality of predefined agriculture activity data and a crop protocol data, wherein the crop protocol data determines a likelihood of particular agricultural activity using spatial temporal parameters, agriculture domain data and crop life cycle data;
comparing, the plurality of sensor data with the plurality of predefined activity data and the crop protocol data to detect an agriculture activity;
generating a monitoring feedback based on the detected agriculture activity;
determining a performance score of the detected agriculture activity;
generating a real time training feedback based on the performance score and the plurality of sensor data; and
providing the monitoring feedback and training feedback to the individual involved in the agricultural activities.

2. The method of claim 1, wherein the monitoring feedback and the training feedback is communicated through at least one of text, a phone call, an interactive voice call, a mobile application or any combination thereof.

3. The method of claim 1, wherein the plurality of sensors comprises on-body sensors and on-field sensors.

4. A system for monitoring agriculture activities and training an individual involved in agricultural activities, the system comprising:
a processor;
a memory coupled with the processor, the memory comprising:
a system repository configured to store predetermined set of rules;
a plurality of sensors configured to sense parameters related to a plurality of agriculture activities and generate a plurality of sensor data, wherein the generated sensor data is stored in the system repository;
a transceiver configured to receive a plurality of processed sensor data from the processor and further configured to transmit said sensor data;
a server coupled with the transceiver to receive said sensor data, said server comprising:
a server repository configured to store predefined activity data and crop protocol data;
an activity detection module having a comparator coupled with the server repository to receive the predefined activity data and the crop protocol data, and configured to compare the plurality of processed sensor data with the plurality of predefined activity data and the crop protocol data to detect an agriculture activity;
a monitoring feedback generator coupled with the activity detection module to receive the determined agriculture activity and configured to generate a monitoring feedback based on the detected agriculture activity;
a training module comprising:
a performance score determiner coupled with the activity detection module to receive the determined agriculture activity and configured to determine a performance score of the detected agriculture activity;
a training feedback generator coupled with the performance scorer to receive the performance score and generate a training feedback based on the performance score;
a communicator coupled with monitoring feedback generator and the training feedback generator to receive the monitoring feedback and training feedback, the communicator configured to provide the feedback to the individual involved in agriculture activities.

5. The system of claim 4, wherein the plurality of sensors comprises on-body sensors and on-field sensors.

6. The system of claim 4, wherein the crop protocol data comprises spatial temporal parameters data, agriculture domain data and crop life cycle data.

7. The system of claim 4, wherein the monitoring feedback generator and the training module are further configured to work independent to each other.

8. The system of claim 4, wherein the activity detection module and the training module are further configured to work independent to each other.

9. The system of claim 4, wherein said monitoring feedback and said training feedback is communicated through text, phone call, interactive voice call, mobile application or any combination thereof.
